(19) United States
(12) Patent Application Publication
(10) Pub. No.: US 2022/0225840 A1
(43) Pub. Date: Jul. 21, 2022

(54) Ladle Strainer Assembly

(71) Applicant: Mark Fordham, Philadelphia, PA (US)

(72) Inventor: Mark Fordham, Philadelphia, PA (US)

(21) Appl. No.: 17/154,019

(22) Filed: Jan. 21, 2021

(51) Int. Cl. A47J 43/28; A47J 19/00

(52) U.S. Cl. CPC A47J 43/281; A47J 19/005

(57) ABSTRACT

A ladle strainer assembly for straining solids from a liquid includes a handle is hollow wherein the handle is configured to be gripped by a user. A bowl is coupled to the handle for dipping into a liquid to scoop a predetermined volume of the liquid. A strainer is pivotally coupled to the handle and the strainer is positionable in a closed position to facilitate liquid to be drained from the bowl while retaining solids in the bowl. An opener is movably integrated into the handle and the opener is in communication with the strainer. The opener urges the strainer between an open position and the closed position to facilitate the user to open and close the strainer without touching the strainer.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to strainer devices and more particularly pertains to a new strainer device for straining solids from a liquid. The device includes a bowl for scooping and a strainer that is closeable over the bowl.

### (2) Description of Related Art Including Information Disclosed Under 37 CFR 1.97 and 1.98

The prior art relates to strainer devices including a ladle that has a bowl shaped strainer. The prior art discloses a variety of strainers that can be positioned over a container for straining a liquid in the container. The prior art also discloses a spoon which includes a perforated element that is closable over the spoon for straining a liquid.

### BRIEF SUMMARY OF THE INVENTION

An embodiment of the disclosure meets the needs presented above by generally comprising a handle is hollow wherein the handle is configured to be gripped by a user. A bowl is coupled to the handle for dipping into a liquid to scoop a predetermined volume of the liquid. A strainer is pivotally coupled to the handle and the strainer is positionable in a closed position to facilitate liquid to be drained from the bowl while retaining solids in the bowl. An opener is movably integrated into the handle and the opener is in communication with the strainer. The opener urges the strainer between an open position and the closed position to facilitate the user to open and close the strainer without touching the strainer.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a ladle strainer assembly according to an embodiment of the disclosure.

FIG. 2 is a perspective view of an embodiment of the disclosure showing a strainer in an open position.

FIG. 3 is a left side view of an embodiment of the disclosure.

FIG. 4 is a left side cut-away view of an embodiment of the disclosure.

FIG. 5 is a left side cut-away view of an embodiment of the disclosure showing a strainer in an open position.

FIG. 6 is a perspective view of an alternative embodiment of the disclosure.

FIG. 7 is a perspective view of an alternative embodiment of the disclosure showing a strainer in an open position.

FIG. 8 is a left view of an alternative embodiment of the disclosure.

FIG. 9 is a left side cut-away view of an alternative embodiment of the disclosure.

FIG. 10 is a left side cut-away view of an alternative embodiment of the disclosure showing a strainer in an open position.

FIG. 11 is a front perspective view of an alternative embodiment of the disclosure.

FIG. 12 is a left side cut-away view of an alternative embodiment of the disclosure showing a strainer in an open position.

### DETAILED DESCRIPTION OF THE INVENTION

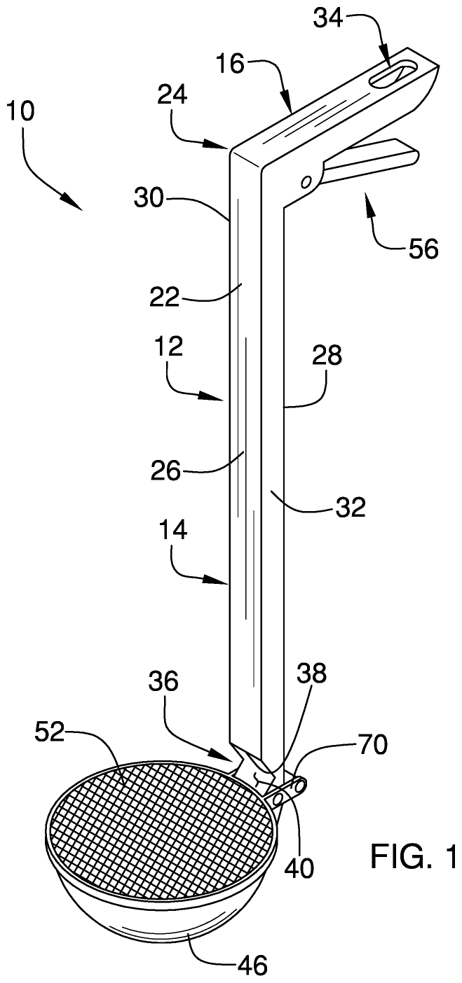

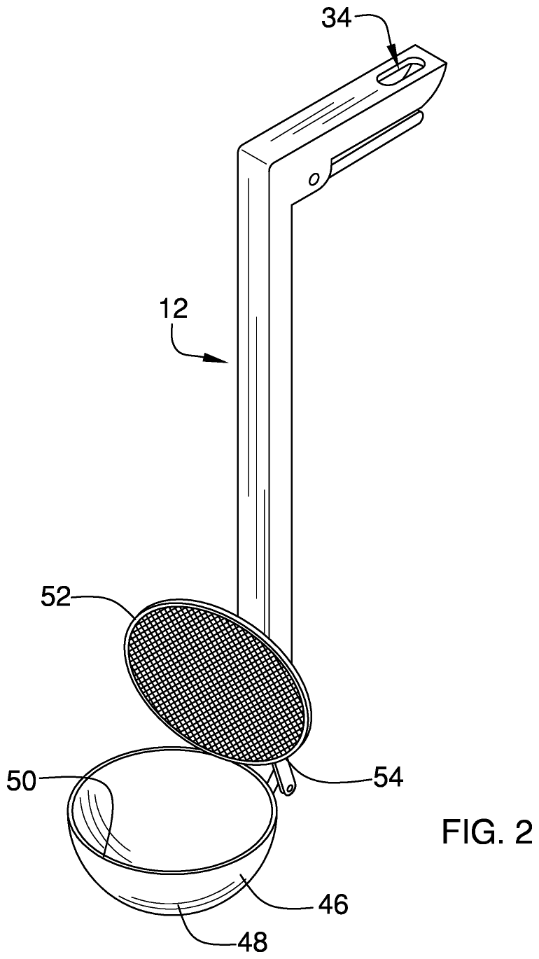

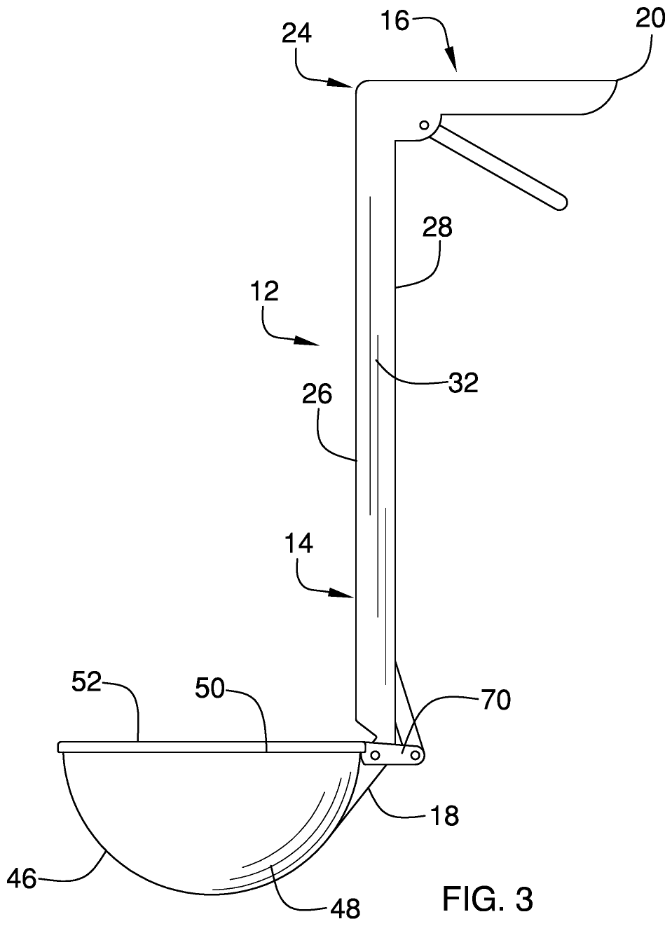

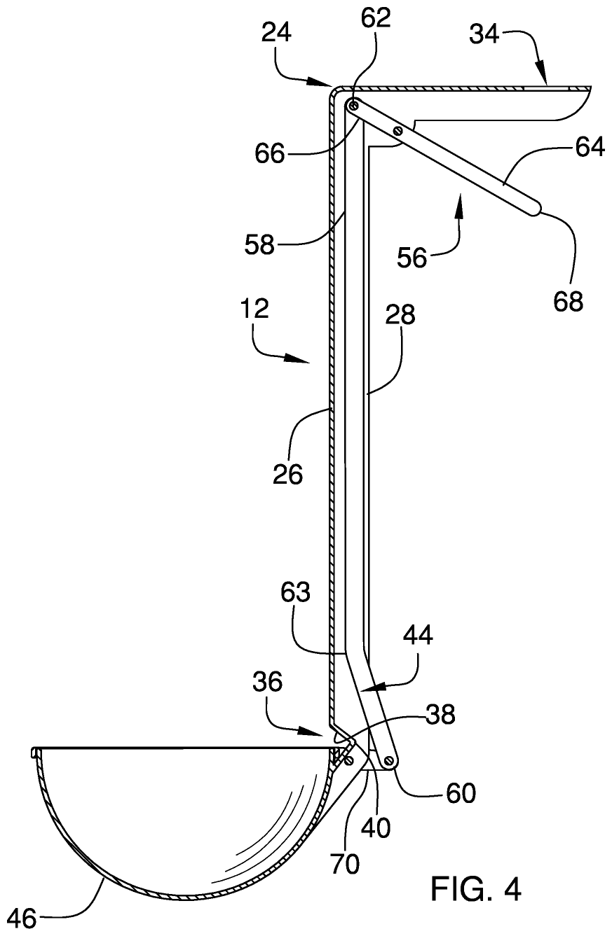

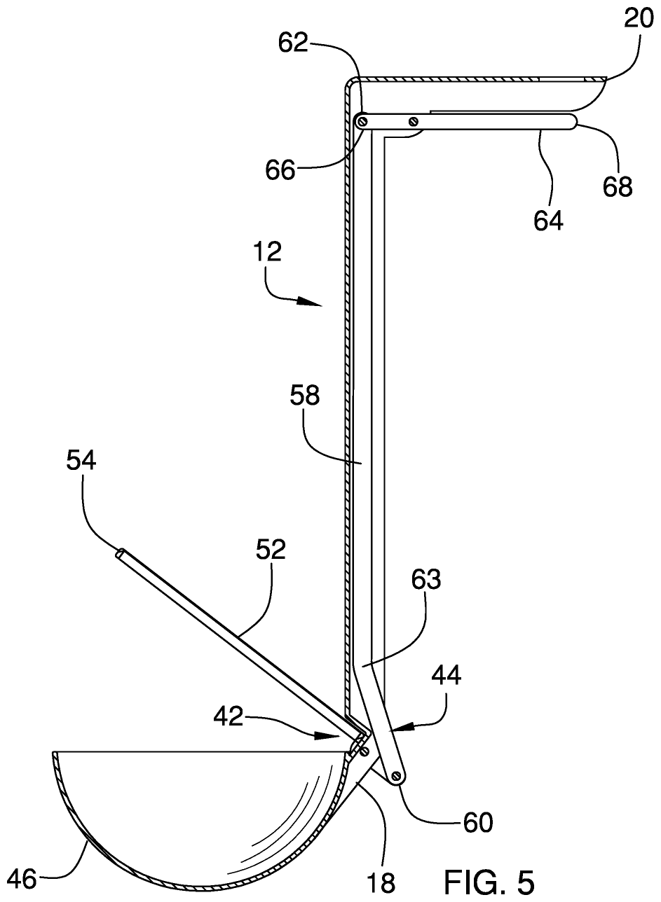

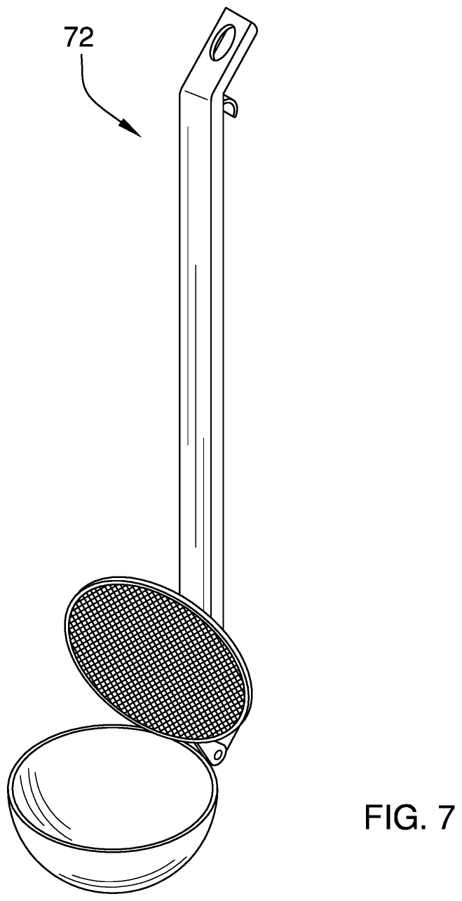

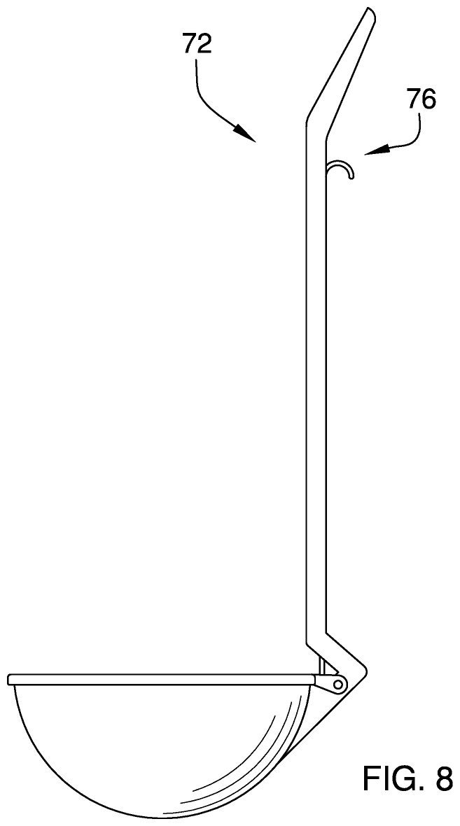

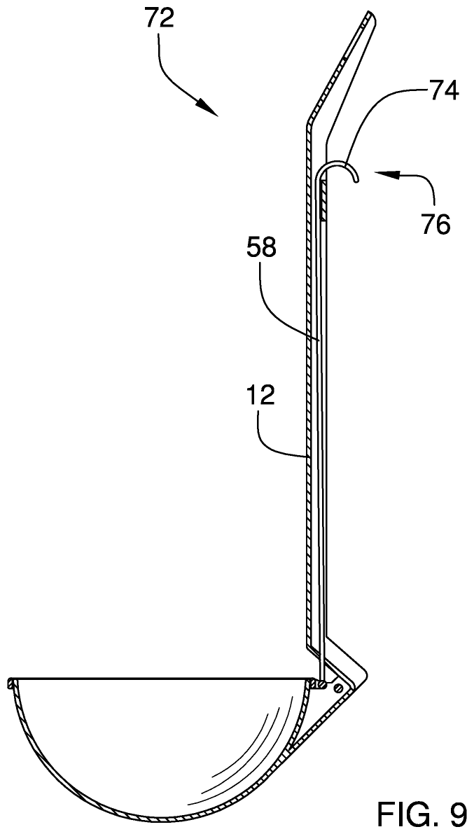

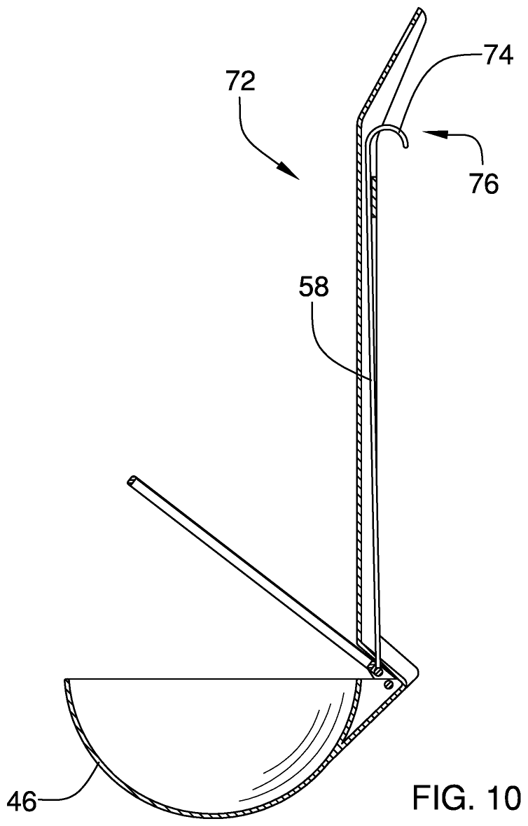

With reference now to the drawings, and in particular to FIGS. 1 through 12 thereof, a new strainer device embodying the principles and concepts of an embodiment of the disclosure and generally designated by the reference numeral 10 will be described.

As best illustrated in FIGS. 1 through 6, the ladle strainer assembly 12 generally comprises a handle 12 that is hollow such that the handle 12 can be gripped by a user. The handle 12 has a first section 14 forming an angle with a second section 16. The handle 12 has a first end 18, a second end 20 and an outer wall 22 extending therebetween, and the outer wall 22 has a bend 24 therein to define the first section 14 and the second section 16. The first end 18 is associated with the first section 14 and the second end 20 is associated with the second section 16. The bend 24 is positioned closer to the second end 20 than the first end 18, and the bend 24 defines a right angle between the first section 14 and the second section 16. The second end 20 is open into an interior of the handle 12, and the outer wall 22 has a front side 26, a back side 28, a first lateral side 30 and a second lateral side 32. The front side 26 of the outer wall 22 corresponding to the second section 16 has a slot 34 extending therethrough to engage a hook for hanging the handle 12 during storage.

The front side 26 of the outer wall 22 corresponding to the first section 14 has a recess 36 extending toward the back side 28 of the outer wall 22 corresponding to the first section 14. The recess 36 extends through each of the first lateral side 30 and the second lateral side 32. Additionally, the recess 36 has a first bounding surface 38 that is oriented at an angle with a second bounding surface 40 such that the recess 36 has a wedge shape. The recess 36 is positioned adjacent to the first end 18, and the second bounding surface 40 has a first hole 42 extending into the interior of the handle 12. The back side 28 of the outer wall 22 corresponding to the first section 14 has a second hole 44 extending into the interior of the handle 12, and the second hole 44 is aligned with the first hole 42.

A bowl 46 is provided that is coupled to the handle 12 and the bowl 46 can be dipped into a liquid for scooping a predetermined volume of the liquid. The bowl 46 has an outside wall 48 and a top edge 50, and the outside wall 48 is coupled to the front side 26 of the outer wall 22 corresponding to the first section 14 of the handle 12. Additionally, the top edge 50 lies on a plane that is oriented perpendicular to the front side 26. The top edge 50 is aligned with the second bounding surface 40 of the recess 36 in the back side 28 of the outer wall 22 corresponding to the first section 14.

A strainer 52 is provided and the strainer 52 is pivotally coupled to the handle 12. The strainer 52 is positionable in a closed position having the strainer 52 covering the bowl 46. In this way the strainer 52 facilitates liquid to be drained from the bowl 46 while retaining solids in the bowl 46. In this way broth can be strained from vegetable soup, for example. The strainer 52 is positionable in an open position having the strainer 52 being displaced from the bowl 46. In this way the bowl 46 can function as a ladle.

The strainer 52 has a perimeter edge 54 and the perimeter edge 54 lies on the top edge 50 of the bowl 46 having the perimeter edge 54 being coextensive with the top edge 50. Additionally, the strainer 52 covers the bowl 46 when the strainer 52 is in the closed position. The perimeter edge 54 is displaced from the top edge 50 when the strainer 52 is in the open position. The strainer 52 is comprised of a mesh material to pass liquid therethrough. Additionally, the strainer 52 is comprised of a rigid material to inhibit solids from passing therethrough. The strainer 52 might also be comprised of a foraminous material for passing liquid therethrough.

An opener 56 is movably integrated into the handle 12 and the opener 56 can be manipulated by a user. The opener 56 is in communication with the strainer 52 and the opener 56 urges the strainer 52 between the open position and the closed position. In this way the opener 56 facilitates the user to open and close the strainer 52 without touching the strainer 52. The opener 56 comprises a rod 58 that has a first end 60 and a second end 62, and the rod 58 is movably positioned within the handle 12. The second end 62 of the rod 58 is aligned the second section 16 of the handle 12 and the first end 60 of the rod 58 is aligned with the second hole 44 in the back side 28 of the outer wall 22 corresponding to the first section 14 of the handle 12. Moreover, the rod 58 has a bend 63 thereon that is positioned adjacent to the first end 60 of the rod 58 such that the rod 58 extends outwardly through the second hole 44 having the first end 60 of the rod 58 being exposed.

The opener 56 includes a lever 64 that has a coupled end 66 and a free end 68, and the coupled end 66 is pivotally coupled to the outer wall 22 corresponding to the second section 16 having the lever 64 being exposed. In this way the lever 64 can be gripped or released by the user. The second end 20 of the rod 58 is pivotally coupled to the coupled end 66 of the lever 64. In this way the rod 58 is lifted upwardly in the handle 12 when the lever 64 is gripped and the rod 58 is lowered downwardly in the handle 12 when the lever 64 is released.

The opener 56 includes a pair of shackles 70 that is each pivotally coupled between the first end 18 of the rod 58 and the perimeter edge 54 of the strainer 52. Each of the shackles 70 extends along a respective one of the first lateral side 30 and the second lateral side 32 of the outer wall 22 corresponding to the first section 14 of the handle 12. Additionally, each of the shackles 70 pivots in a first direction when the lever 64 is gripped thereby tilting the strainer 52 into the open position. Conversely, each the shackles 70 pivots in a second direction when the lever 64 is released thereby lowering the strainer 52 into the closed position.

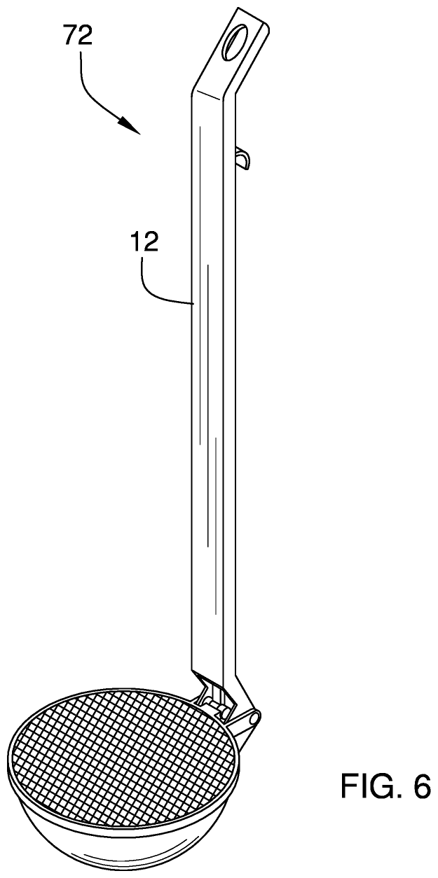

In an alternative embodiment 72 as is most clearly shown in FIGS. 6 through 10, the bend 24 on the handle 12 defines an obtuse angle between the first section 14 of outer wall 22 of the handle 12 and the second section 16 of the outer wall 22 of the handle 12. Additionally, the back side 28 of the outer wall 22 corresponding to the second section 16 is open into the interior of the handle 12. Continuing in the alternative embodiment 72, the rod 58 has a curve 74 thereon that is positioned adjacent to the second end 20 of the rod 58 to define a hook 76 extending outwardly from the back side 28 of the outer wall 22 corresponding to the second section 16. Additionally, the hook 76 can be gripped by the user for lifting and lowering the rod 58. The first end 18 of the rod 58 is positioned within the handle 12 and the first end 18 is pivotally coupled to a pin extending between each of the shackles 70. Each of the first bounding surface 38 and the second bounding surface 40 of the recess 36 is open thereby exposing the rod 58.

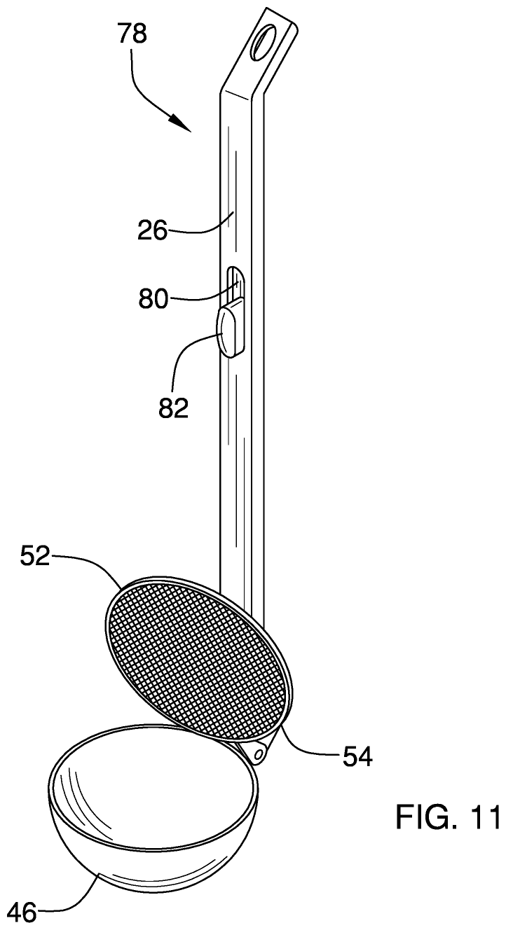

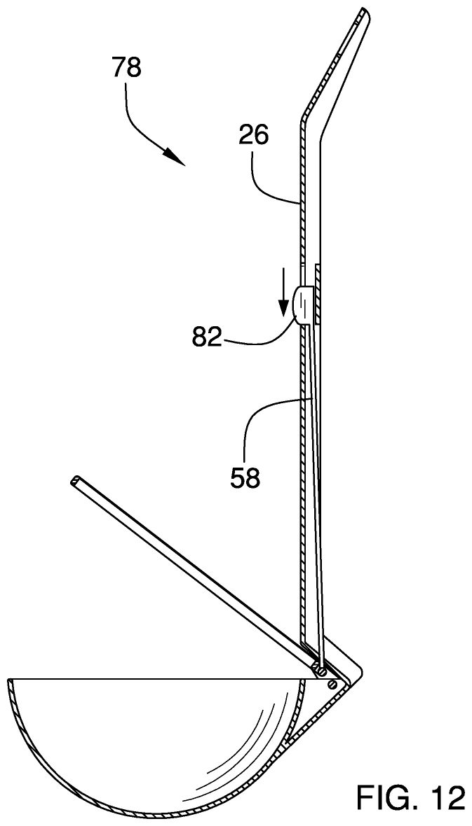

As is most clearly shown in an alternative embodiment 78 as is most clearly shown in FIGS. 11 and 12, the front side 26 of the outer wall 22 corresponding to the first section 14 has a button slot 80 extending into the interior of the handle 12. Continuing in the alternative embodiment 78, a button 82 is coupled to the rod 58 and the button 82 is positioned adjacent to the second end 20 of the rod 58. Moreover, the button 82 extends outwardly through the button slot 80 such that the button 82 can be manipulated by a user. In this way the rod 58 can be slid upwardly and downwardly in the handle 12.

In use, the lever 64 is gripped to urge the strainer 52 into the open position for scooping a liquid and solids in the liquid, such as broth and vegetables in vegetable soup. The lever 64 is gripped to empty the liquid and the solids from the bowl 46. Conversely, the lever 64 can be released to empty only the liquid from the bowl 46 while retaining the solids in the bowl 46. In this way the broth of the vegetable soup could be strained from the vegetables of the vegetable soup. Additionally, the lever 64 could be released to position the strainer 52 in the closed position for scooping only a liquid and no solids in the liquid.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A ladle strainer assembly for straining a fluid food product in preparation for serving the fluid food product, said assembly comprising:
a handle being hollow wherein said handle is configured to be gripped by a user, said handle having a first section forming an angle with a second section;
a bowl being coupled to said handle wherein said bowl is configured to be dipped into a liquid for scooping a predetermined volume of the liquid;
a strainer being pivotally coupled to said handle, said strainer being positionable in a closed position having said strainer covering said bowl wherein said strainer is configured to facilitate liquid to be drained from said bowl while retaining solids in said bowl, said strainer being positionable in an open position having said strainer being displaced from said bowl; and
an opener being movably integrated into said handle wherein said opener is configured to be manipulated by a user, said opener being in communication with said strainer, said opener urging said strainer between said open position and said closed position wherein said opener is configured to facilitate the user to open and close said strainer without touching said strainer.

2. The assembly according to claim 1, wherein said handle has a first end, a second end and an outer wall extending therebetween, said outer wall having a bend therein to define said first section and said second section, said first end being associated with said first section, said second end being associated with said second section, said bend being positioned closer to said second end than said first end, said bend defining a right angle between said first section and said second section, said second end being open into an interior of said handle.

3. The assembly according to claim 2, wherein said outer wall has a front side, a back side, a first lateral side and a second lateral side, said front side of said outer wall corresponding to said second section having a slot extending therethrough wherein said slot is configured to engage a hook for hanging said handle during storage.

4. The assembly according to claim 3, wherein said front side of said outer wall corresponding to said first section has a recess extending toward said back side of said outer wall corresponding to said first section, said recess extending through each of said first lateral side and said second lateral side, said recess having a first bounding surface being oriented at an angle with a second bounding surface such that said recess has a wedge shape, said recess being positioned adjacent to said first end.

5. The assembly according to claim 4, wherein said second bounding surface has a first hole extending into said interior of said handle.

6. The assembly according to claim 5, wherein said back side of said outer wall corresponding to said first section has a second hole extending into said interior of said handle, said second hole being aligned with said first hole.

7. The assembly according to claim 4, wherein said bowl has an outside wall and a top edge, said outside wall being coupled to said front side of said outer wall corresponding to said first section of said handle having said top edge lying on a plane being oriented perpendicular to said front side, said top edge being aligned with said second bounding surface of said recess in said back side of said outer wall corresponding to said first section.

8. The assembly according to claim 7, wherein said strainer has a perimeter edge, said perimeter edge lying on said top edge of said bowl having said perimeter edge being coextensive with said top edge such that said strainer covers said bowl when said strainer is in said closed position, said perimeter edge being displaced from said top edge when said strainer is in said open position.

9. The assembly according to claim 6, wherein said opener comprises a rod having a first end and a second end, said rod being movably positioned within said handle having said second end of said rod being aligned said second section of said handle and having said first end of said rod being aligned with said second hole in said back side of said outer wall corresponding to said first section of said handle.

10. The assembly according to claim 9, wherein said rod has a bend thereon being positioned adjacent to said first end of said rod such that said rod extends outwardly through said second hole having said first end of said rod being exposed.

11. The assembly according to claim 9, wherein said opener comprises a lever having a coupled end and a free end, said coupled end being pivotally coupled to said outer wall corresponding to said second section having said lever being exposed wherein said lever is configured to be gripped or released by the user, said second end of said rod being pivotally coupled to said coupled end of said lever, said rod being lifted upwardly in said handle when said lever is gripped, said rod being lowered downwardly in said handle when said lever is released.

12. The assembly according to claim 10, wherein said opener comprises a pair of shackles, each of said shackles being pivotally coupled between said first end of said rod and a perimeter edge of said strainer, each of said shackles extending along a respective one of said first lateral side and said second lateral side of said outer wall corresponding to said first section of said handle, each of said shackles pivoting in a first direction when said lever is gripped thereby tilting said strainer into said open position, each said shackles pivoting in a second direction when said lever is released thereby lowering said strainer into said closed position.

13. A ladle strainer assembly for straining a fluid food product in preparation for serving the fluid food product, said assembly comprising:
a handle being hollow wherein said handle is configured to be gripped by a user, said handle having a first section forming an angle with a second section, said handle having a first end, a second end and an outer wall extending therebetween, said outer wall having a bend therein to define said first section and said second section, said first end being associated with said first section, said second end being associated with said second section, said bend being positioned closer to said second end than said first end, said bend defining a right angle between said first section and said second section, said second end being open into an interior of said handle, said outer wall having a front side, a back side, a first lateral side and a second lateral side, said front side of said outer wall corresponding to said second section having a slot extending therethrough wherein said slot is configured to engage a hook for hanging said handle during storage, said front side of said outer wall corresponding to said first section having a recess extending toward said back side of said outer wall corresponding to said first section, said recess extending through each of said first lateral side and said second lateral side, said recess having a first bounding surface being oriented at an angle with a second bounding surface such that said recess has a wedge shape, said recess being positioned adjacent to said first end, said second bounding surface having a first hole extending into said interior of said handle, said back side of said outer wall corresponding to said first section having a second hole extending into said interior of said handle, said second hole being aligned with said first hole;
a bowl being coupled to said handle wherein said bowl is configured to be dipped into a liquid for scooping a predetermined volume of the liquid, said bowl having an outside wall and a top edge, said outside wall being coupled to said front side of said outer wall corresponding to said first section of said handle having said top edge lying on a plane being oriented perpendicular to said front side, said top edge being aligned with said second bounding surface of said recess in said back side of said outer wall corresponding to said first section;
a strainer being pivotally coupled to said handle, said strainer being positionable in a closed position having said strainer covering said bowl wherein said strainer is configured to facilitate liquid to be drained from said bowl while retaining solids in said bowl, said strainer being positionable in an open position having said strainer being displaced from said bowl, said strainer having a perimeter edge, said perimeter edge lying on said top edge of said bowl having said perimeter edge being coextensive with said top edge such that said strainer covers said bowl when said strainer is in said closed position, said perimeter edge being displaced from said top edge when said strainer is in said open position, said strainer being comprised of a mesh material wherein said strainer is configured to pass liquid therethrough, said strainer being comprised of a rigid material wherein said strainer is configured to inhibit solids from passing therethrough; and
an opener being movably integrated into said handle wherein said opener is configured to be manipulated by a user, said opener being in communication with said strainer, said opener urging said strainer between said open position and said closed position wherein said opener is configured to facilitate the user to open and close said strainer without touching said strainer, said opener comprising:
a rod having a first end and a second end, said rod being movably positioned within said handle having said second end of said rod being aligned said second section of said handle and having said first end of said rod being aligned with said second hole in said back side of said outer wall corresponding to said first section of said handle, said rod having a bend thereon being positioned adjacent to said first end of said rod such that said rod extends outwardly through said second hole having said first end of said rod being exposed;
a lever having a coupled end and a free end, said coupled end being pivotally coupled to said outer wall corresponding to said second section having said lever being exposed wherein said lever is configured to be gripped or released by the user, said second end of said rod being pivotally coupled to said coupled end of said lever, said rod being lifted upwardly in said handle when said lever is gripped, said rod being lowered downwardly in said handle when said lever is released; and
a pair of shackles, each of said shackles being pivotally coupled between said first end of said rod and said perimeter edge of said strainer, each of said shackles extending along a respective one of said first lateral side and said second lateral side of said outer wall corresponding to said first section of said handle, each of said shackles pivoting in a first direction when said lever is gripped thereby tilting said strainer into said open position, each said shackles pivoting in a second direction when said lever is released thereby lowering said strainer into said closed position.

14. The assembly according to claim 13, wherein said bend defines an obtuse angle between said first section of outer wall of said handle and said second section of said outer wall of said handle, said back side of said outer wall corresponding to said second section being open into said interior of said handle.

15. The assembly according to claim 14, wherein said rod has a curve thereon being positioned adjacent to said second end of said rod to define a hook extending outwardly from said back side of said outer wall corresponding to said second section wherein said hook is configured to be gripped by the user for lifting and lowering said rod.

16. The assembly according to claim 15, wherein said first end of said rod is positioned within said handle, said first end being pivotally coupled to a pin extending between each of said shackles.

17. The assembly according to claim 16, wherein each of said first bounding surface and said second bounding surface of said recess is open thereby exposing said rod.

18. The assembly according to claim 13, wherein front side of said outer wall corresponding to said first section has a button slot extending into said interior of said handle.

19. The assembly according to claim 18, further comprising a button being coupled to said rod, said button being positioned adjacent to said second end of said rod, said button extending outwardly through said button opening wherein said button is configured to be manipulated by a user.
